(19) United States
(12) Patent Application Publication
(10) Pub. No.: US 2023/0099492 A1
(43) Pub. Date: Mar. 30, 2023

(54) GENERATION AND PRESENTATION OF DYNAMIC ITEM QUANTITIES

(71) Applicant: Amazon Technologies, Inc., Seattle, WA (US)

(72) Inventors: Donald Christopher Woods, Seattle, WA (US); Wesley Lauka, Seattle, WA (US)

(21) Appl. No.: 17/485,854

(22) Filed: Sep. 27, 2021

(51) Int. Cl. G06Q 30/06

(52) U.S. Cl. CPC G06Q 30/0627; G06Q 30/0643

(57) ABSTRACT

A computer system may receive a request that includes a requested weight quantity of an item and identifies the item. The computer system may use this information to lookup correlating information for the item. The correlating information may correlate item weight with item quantity. The computer system may use the correlating information and the weight quantity to determine a corresponding numerical quantity of the item. A visual indicator that represents the numerical quantity of the item may be presented in a user interface to provide context for how the requested weight quantity translates to the numerical quantity.

### BACKGROUND

Items, including food items, can be obtained online. This can include food items typically obtained by a certain form of measurement (e.g., by the pound). Computers, including mobile electronic devices, can display representative images of food items available online.

### BRIEF DESCRIPTION OF THE DRAWINGS

Various examples in accordance with the present disclosure will be described with reference to the drawings, in which:

FIG. 1 illustrates an example block diagram and associated flowchart showing a process for implementing techniques relating to generating and presenting visual indicators relating to dynamic item quantities, according to at least one example;

FIG. 2 illustrates an example system for implementing techniques relating to generating and presenting visual indicators relating to dynamic item quantities, according to at least one example;

FIG. 3 illustrates a view of an example user interface at which techniques relating to generating and presenting visual indicators relating to dynamic item quantities may be implemented, according to at least one example;

FIG. 4 illustrates a subsequent view of the example user interface of FIG. 3, according to at least one example;

FIG. 5 illustrates an example schematic architecture for implementing techniques relating to generating and presenting visual indicators relating to dynamic item quantities, according to at least one example;

FIG. 6 is an example flow diagram depicting example acts for implementing techniques relating to generating and presenting visual indicators relating to dynamic item quantities, according to at least one example;

FIG. 7 is an example flow diagram depicting example acts for implementing techniques relating to generating and presenting visual indicators relating to dynamic item quantities, according to at least one example;

FIG. 8 is an example schematic environment for implementing techniques relating to generating and presenting visual indicators relating to dynamic item quantities, according to at least one example.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples described herein are directed to, among other things, techniques for determining and presenting images relating to dynamic item quantities. The images may relate to items available for procurement via an electronic store or other suitable site. The techniques may be especially useful when applied to items that are fungible (e.g., produce items) and that are offered using a first unit of measurement such as weight (e.g., $5 per pound). Typically, these types of items are represented by stock images that may remain the same irrespective of the quantity of items in one's cart and/or the estimated quantity of items resulting from a pound-based request. This leads to user confusion because regardless of how much of something the user adds to their cart, what the user sees in their cart remains the same. Thus, a user may have difficulty maintaining a clear understanding of how the price per pound translates to a real-world quantity. This leads to user frustration, food waste, and other related problems with obtaining too many items or too few.

Turning now to a particular example, a system is provided that includes a service provider computer that enables user access (e.g., using a smartphone application, web application, website, etc.) to an electronic store that offers food items. The system obtains correlating information from upstream entities relating to the food items and uses that information for further computations. The upstream entities, which may include item producers, sellers, and any other entity that interacts with the food items before being sold, generate the correlating information according to some fixed interval (e.g., daily), based on triggering events (e.g., when a new shipment arrives, when the information changes beyond some threshold), and/or when requested. The correlating information correlates item weight with item quantity (e.g., average number of items per pound). For example, for a particular type of potatoes such as Yukon gold, the correlating information may indicate an average weight, volume, and/or shape for a single Yukon gold potato. This correlating information may change periodically (e.g., depending on supplier, time of year, etc.). To ensure that the system has the most accurate information for food items, computer systems of the upstream entities may update and share the correlating information in a dynamic manner. The system is configured to dynamically receive and process the correlating information from multiple different types of sources (e.g., automated sensor readings, information input by users at computer terminals, etc.). The correlating information, once processed by the system, can be used to dynamically estimate a numerical quantity of the food item responsive to user requests. For example, using an electronic device, a user may request ten pounds of Yukon Gold potatoes, and the system may access correlating information on file for the current stock of Yukon Gold potatoes to determine that, on average, a single Yukon Gold potato weighs around 1/4 pound. With this information, the system may determine that, based on the average of 1/4 pound per potato, the user's request for ten pounds is equal to forty potatoes. This numerical quantity is more readily understandable by the user. Not only does the system estimate the numerical quantity associated with the user's request, but also dynamically generates a visual indicator that represents the numerical quantity. The visual indicator is then provided for presentation at a display of the user's electronic device. The visual indicator may be a single composite image including forty potatoes, forty image tiles each depicting a potato, or any other suitable approach for representing the numerical quantity. The visual indicator may be presented on a display of the user's electronic device in a manner that enables the user to understand how many potatoes they will receive if they go forward with the ten-pound order. The visual indicator may be generated based on stock photos of the food item, may be generated based on one or more actual images of an example item represented by the correlating information (e.g., an image may be taken as part of the weighing and measuring information gathering step), and/or in any other suitable manner.

The techniques described herein improve the functioning of computer systems such as service provider systems and computer systems such as user devices. Because correlating information is maintained by the service provider and used for responding to user requests, users can perform purchasing processes efficiently and with fewer mistakes as compared to traditional techniques that do not present images that correspond to a weight quantity of items. Because of this efficiency and the fact that the users are less likely to have to perform the purchasing process a second time, user devices are connected to backend servers for less time, resulting in bandwidth savings and freeing up resources for other users. Additionally, because the images are obtained in real-time and tailored to the respective request, navigation to other websites to estimate conversion from weight to quantity is not typically required. Thus, computing resources (e.g., processing cycles) and networking resources (e.g., bandwidth) on both the backend servers and the user devices are conserved.

Additionally, as described in some examples, the techniques described herein improve efficiency of using the user devices to perform purchasing by reducing the number of clicks, selections, scrolling operations, new webpages, page refreshes, and the like required of a user to complete the purchasing process using a user interface. For example, upon detection of a user request including a weight quantity of an item, the user interface can be automatically adjusted to include a set of images of the item that the user will actually receive if the weight quantity is ordered. The information about the item, along with the images of the item are all presented simultaneously using the same user interface. Similarly, if the user simply updates the weight quantity requested, the images will update automatically, which immediately gives the user a complete understanding of how many items will be received if ordered. Using conventional techniques, this same operation could take many more than one user operation (e.g., making a request, using a calculator to convert the quantity, etc.), which even if completed still would not include a set of images of the items.

Additionally, the techniques described herein improve the experience of purchasing items by weight by reducing the cognitive load typically associated with such purchasing. Such reduction is possible because the user is not required to guess the quantity of items given a particular weight, as a result of the system obtaining and maintaining dynamic item information from the upstream systems. Because the system is able to represent quantity of items clearly in the set of images, the user will have a good understanding and expectation of what will ultimately be delivered, if ordered. This results in increased user satisfaction, fewer returns of items, and an overall conservation of resources, including computing resources and physical resources. Additionally, because the user will very rarely have to turn to a different source for information for understanding the conversion of pounds to quantities, the user is less likely to be distracted by irrelevant information in the different source and encountered along the way.

While the techniques of this specification are described with respect to images and visual indicators, it should be understood that any suitable indicator capable of identifying an item may also be used. For example, three-dimensional models, videos, Graphics Interchange Format (GIFs), and the like may be used in place of or in addition to the images and/or visual indicators.

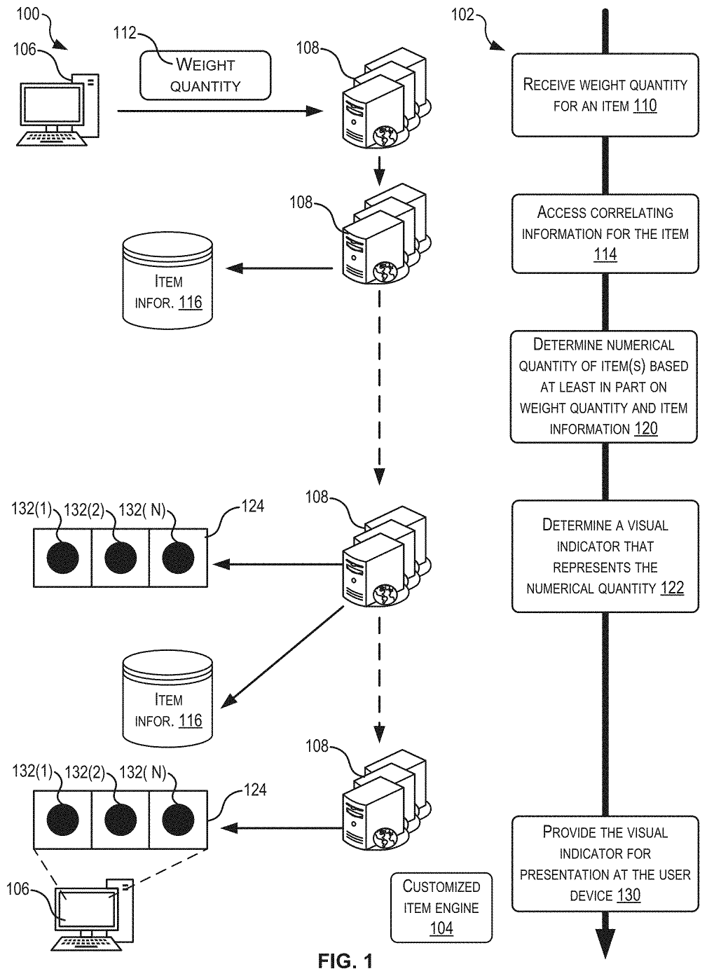

Turning now to the figures, FIG. 1 is an example block diagram 100 and associated flowchart showing a process 102 for implementing techniques relating to generating and presenting visual indicators relating to dynamic item quantities, according to at least one example. The diagram 100 depicts devices, objects, and the like that correspond to the process 102. The process 102 can be performed by a customized item engine 104, which may be implemented in a server computer (e.g., service provider 108) to maintain dynamic correlating information and respond to user requests from user devices 106 and/or in the user device 106. The user requests may be responded to in the form of webpages, web services, and the like for facilitating researching and purchasing items. In some examples, at least a portion of the customized item engine 104 is implemented by the user device 106.

The process 102 may begin at block 110 by the service provider 108 receiving a weight quantity 112 for an item. The weight quantity 112 may be received from the user device 106 as part of a request issued by the user device 106 within an electronic store application provided by the service provider 108 to the user device 106. The weight quantity 112 may include a numerical quantity such as a natural number (e.g., 1, 2, 3, 4, etc.), as well as fractions (e.g., ½, ¼, ⅛, etc.). The message that includes the weight quantity and/or a different message obtained as part of the same session between the user device 106 and the service provider 108 may include an item identifier. The item identifiers may be specific to items offered by an electronic store provided by the service provider 108. In some examples, the item identifier may be a unique identifier that uniquely identifies the item, irrespective of seller and/or supplier. In some examples, however, the item identifier may differ for the same items offered by different sellers, supplied by different suppliers, and the like. This may enable tracking of items at a greater level of granularity than at an item level.

At block 114, the process 102 includes the service provider 108 accessing correlating information for the item. This may include accessing correlating information in an item information database 116. In some examples, this may include using the item identifier as a lookup key to access the correlating information in the item information database 116. The service provider 108 may maintain the correlating information in the item information database 116. The correlating information may be stored using any suitable structure and may include any suitable static fields such as, for example, item name, item seller, item supplier, item identifier, stock or custom image, and the like. The correlating information may also include dynamic fields, which may include some of the fields recited previously, along with fields relating to correlating characteristics such as, for example, average weight, average volume, average shape, and the like. As described herein, such correlating information may be obtained dynamically from one or more other systems. The correlating information may be processed and stored to the item information database 116 by the service provider 108 in about real-time. This may enable the service provider 108 to have access to current item information. Examples of items for which item information can be stored in the item information database 116 include, for example, fruit, vegetables, nuts, cuts of meat, eggs, fish, and any other item typically purchased by weight.

At block 120, the process 102 includes the service provider 108 determining a numerical quantity of items based at least in part on the weight quantity and the correlating information. This may also include estimating the numerical quantity. This may include the service provider 108 performing one or more computing operations that convert the weight quantity to the numerical quantity using the item information (e.g., an average weight per item).

At block 122, the process 102 includes the service provider 108 determining a visual indicator 124 that represents the numerical quantity. The visual indicator may include multiple representations of the item that are equal in number to the numerical quantity. For example, if the numerical quantity determined at 120 were three, the number of representations 132 may also equal three. The number of representations 132 may be limited only by the area on the user interface at which the visual indicator 124 will be presented. Determining the visual indicator 124 may include obtaining the visual indicator 124 based at least in part on item information. This may include the service provider 108 obtaining the visual indicator 124 from the item information database 116. This may include using an item identifier as a lookup key for accessing the visual indicator. In some examples, the block 128 includes the service provider 108 generating the visual indicator based on characteristic information about the item. For example, the item information may include a three-dimensional model of the item and other characteristic information (e.g., surface properties, dimensions, etc.), and, at run-time, the service provider 108 may generate the visual indicator. The service provider 108 may also, in some examples, precompute the visual indicator (e.g., prior to run time) and store those visual indicators in the item information database 116 and/or in a different data structure accessible to the service provider 108.

At block 130, the process 102 includes the service provider 108 providing the visual indicator 124 including multiple visual representations 132 of the item for presentation at the user device 106 This may be the visual indicator that was the subject of block 122. Thus, the correspondence of visual representations 132 and the numerical quantity may be 1:1. This correspondence may give the user a meaningful view of how many items the user will receive.

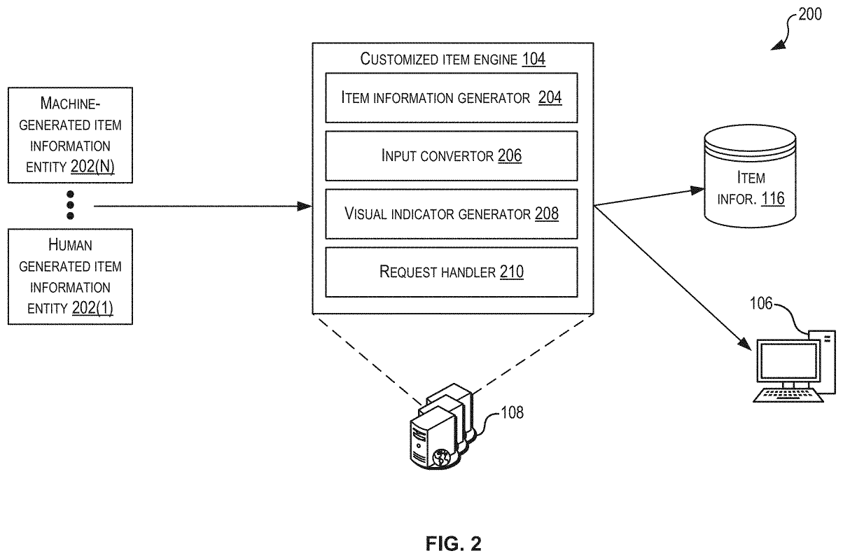

FIG. 2 illustrates an example system 200 for implementing techniques relating to generating and presenting visual indicators relating to dynamic item quantities, according to at least one example. The system includes some elements from FIG. 1 (e.g., the user device 106, the service provider 108, the customized item engine 104, and the item information database 116), along with item information generating entities 202. The item information generating entities 202(1)-202(N) are examples of the upstream entities described herein. In particular, the item information generating entities 202 may be configured to dynamically generate and provide current item information to the service provider 108. The service provider 108 stores this information in the item information database 116, and use it to respond to requests from the user device 106. In some examples, the service provider 108 may respond to such requests using streaming and/or non-stored current item information received from the item information generating entities 202.

The item information generating entities 202 may include any suitable device, system, sensor, combination of the foregoing, and/or any other suitable device (or combination of devices) capable of obtaining, processing, and/or sharing correlating information with the service provider 108. For example, the item information generating entity 202(1) may include information that is generated by a human user. For example, a user may selectively measure particular items (e.g., food items) and using a computing device (e.g., tablet or other device) input values for these measurements. This information may be used to generate the average values for items described herein. In some examples, this same process may include information from machine-generated entity 202(N). For example, rather than the user inputting the information, the computing device may be used to capture images and/or use other sensors to scan individual items. This information may be machine obtained and generated and shared with the service provider 108. Other examples of systems that can generate machine generated item information include overhead scanners, electronic scales, cameras, and the like. The item information generated by entities 202 may include aspects that a human generated and aspects that are machine generated. For example, a butcher may cut standard steaks and individually place them on a scale, and the scale may report the values to the service provider 108 and/or to a different computer system that tallies the values and computes average values (e.g., weight), which are then shared with the service provider 108. The item information 202 may be associated with a particular item identifier maintained by the service provider 108 and/or provided to the service provider 108 with the item information 202.

In the system 200, the service provider 108 is illustrated as including the customized item engine 104. The customized item engine 104 may be implemented in software, hardware, firmware, and/or any combination of the same. In some examples, the customized item engine 104 may be implemented using a Cloud-based server system and/or any other suitable system. As illustrated, the customized item engine 104 includes a set of engines, modules, components, or the like associated with certain functions of the customized item engine 104. It should be appreciated that while the discrete elements are listed, the customized item engine 104 is not limited solely to this configuration. The customized item engine 104 may include an item information generator 204, an input convertor 206, a visual indicator generator 208, and a request handler 210.

Generally, the item information generator 204 may be configured to generate item information (e.g., correlating information) based on information obtained from the item information generating entities 202. This may include maintaining real-time connections with the item information generating entities 202 such that the item information generator 204 receives updates from the entities 202 when their respective information is updated. This dynamic approach for information sharing may enable the customized item engine 104 to deliver accurate item information as part of responding to user requests.

Generally, the input convertor 206 may be configured to convert user requests from one form to a different form. For example, if per pound quantity is received, the input convertor 206 may use this information in connection with information generated by the item information generator 204 (e.g., average weight per item) to determine a numerical quantity equivalent of the per pound quantity.

Generally, the visual indicator generator 208 may be configured to generate visual indicators of items of interest. This may include accessing stock images or actual images from the item information database 116 and/or other database. This may also include, in some examples, the image generator 208 dynamically compositing and/or generating the images based on other information.

Generally, the request handler 210 may be configured to handle (e.g., receive and respond) requests from the user device 106. This may include proxying the requests to other entities within the service provider 108 to handle. In some examples, the request handler 210 may receive a request for an item and once the other engines have performed their respective functions, the request handler 210 may respond to the user device 106 with the requested information.

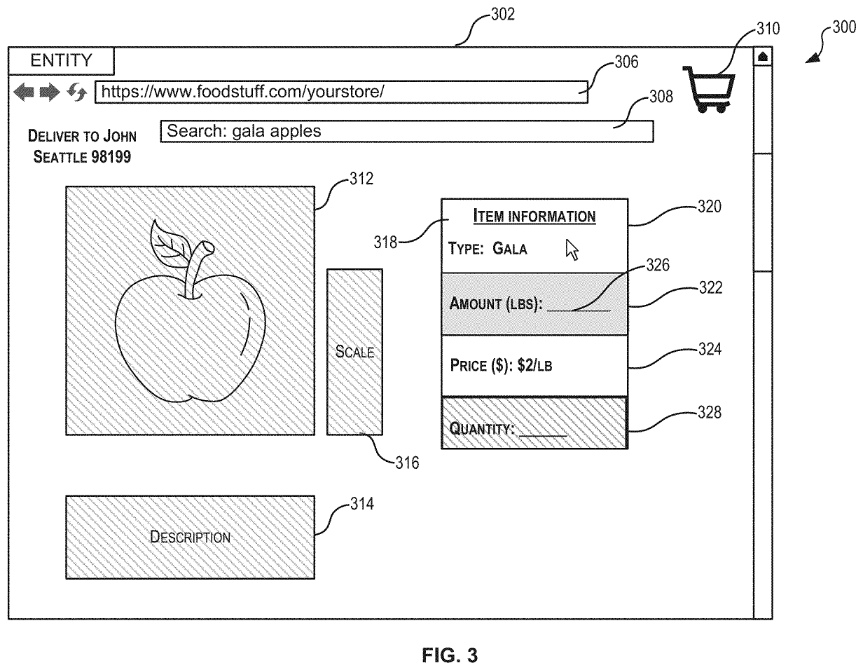

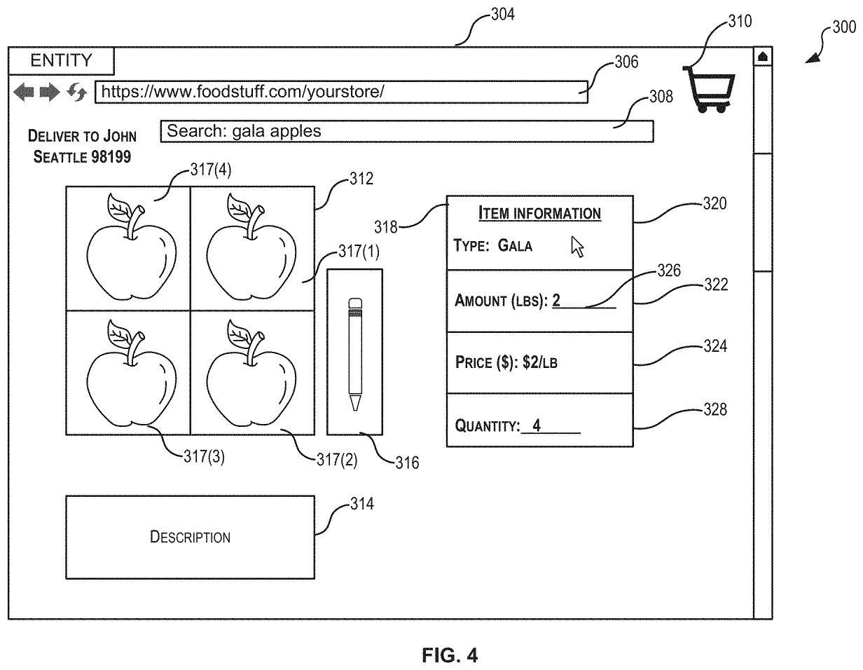

FIGS. 3 and 4 illustrate views 302 and 304 of an example user interface 300 at which techniques relating to generating and presenting visual indicators relating to dynamic item quantities may be implemented, according to various examples. The user interface 300 may be configured generally to provide access to an electronic store. The precise layout and views may differ depending on how the user interface 300 is presented at the user device. For example, a mobile application may be different from a web application, as illustrated.

The user interface 300 is presented in a web browser, which includes navigation area 306 including an address bar and navigation button (e.g., forward, back, refresh). The address bar depicts the address of the webpage represented by the user interface 300. The user interface 300 includes a search bar 308 for searching for items, a cart indicator 310 for viewing items added to the cart, an image area 312, a description area 314, a scale image area 316, and an item information area 318.

Beginning with the navigation area 306, in the view 302, a user has input “Gala apple” into the search bar of the navigation area 306. This search may be suitably specific for the service provider 108 to serve up the view 302. In some examples, the user may drill down through a set of search results to arrive at the view 302 (e.g., by filtering and/or selecting from a set of search results presented on a different page). In some examples, the item information area 318 may be used to present general information about the specific item—“Gala apple.” In some examples, the view 302 may be specific to an item identifier. Thus, a view for a “Honeycrisp apple” may be different at least because elements of the view will present different information. In particular, the item information 320 presents information specific to the “Gala apple” item. This includes type information 320 that identifies the type of apple as “Gala.” The item information area 318 also includes amount information 322 that identifies the units by which the type of item is sold (e.g., by the pound, by the ounce, by the tone, by the cubic inches, by the cubic feet, etc.) and includes a field 326 for input and/or selection of a quantity based on the unit. The item information area 318 also includes a price area 324 that identifies the currency by which the type of item is sold and a price of the item at the unit rate. Finally, the item information area 318 includes item quantity area 328. The item quantity area 328 is used to present a numeral quantity of items when the user inputs a value into the field 326.

The image area 312 is used to present an image of a single item (e.g., a single Gala apple). At this point, the image is presented to provide the user with a representation of what the item looks like. The description area 314 may include a short description of the item. The scale image area 316 may be used to present a reference image at a later time that can be used to approximate the size of the items. The reference image may be of an item that is commonly understood by users or a measuring device (e.g., a ruler). For example, the reference image may depict a pencil, a can of soda, a soup can, and any other such item. This reference image may be scaled depending on the size of the images, the items depicted, and/or quantity of the images in the image area 312.

As described in more detail with respect to FIG. 4, the information input in the field 326 may cause the user device showing the user interface 400 to send a request to the service provider for correlating information described herein. This may also cause the user device to update the user interface 300 to present the view 304. During this process, the elements that are shown with dashed hashing (e.g., 328, 312, 316, and 314) in FIG. 3 may be updated, as shown in FIG. 4. The item information area 318 may also be updated to include additional row(s). For example, in FIG. 4, the user has requested 2 pounds of Gala apples (e.g., based on input in field 326 in FIG. 4). Based on this input, the techniques described are implemented to determine that 2 pounds of Gala apples is equal to 4 apples. Thus, the item quantity area 328 in the item information area 318 has been updated to reflect a numerical quantity of 4. Similarly, the image area 312 has been divided into four equally-sized spaces 317 and an image of a Gala apple has been placed in each space. This gives the user an understanding of how many apples they will receive if they order 2 pounds. The description area 314 may also be updated to include a description of the Gala apples and, in some examples, a description of the particular Gala apples under consideration. For example, the description area 314 may be updated with information about where the apples were grown, what the average dimensions are (e.g., weight, height, width, length, circumference, volume, etc.), the exact computation for arriving at the four apples (e.g., did the system round down to get to four apples or round up), and any other information. A reference image (e.g., a pencil) has been added to the scale area 316. This reference image has been scaled to correspond to the depicted dimensions of the images of the apples in the image area 312.

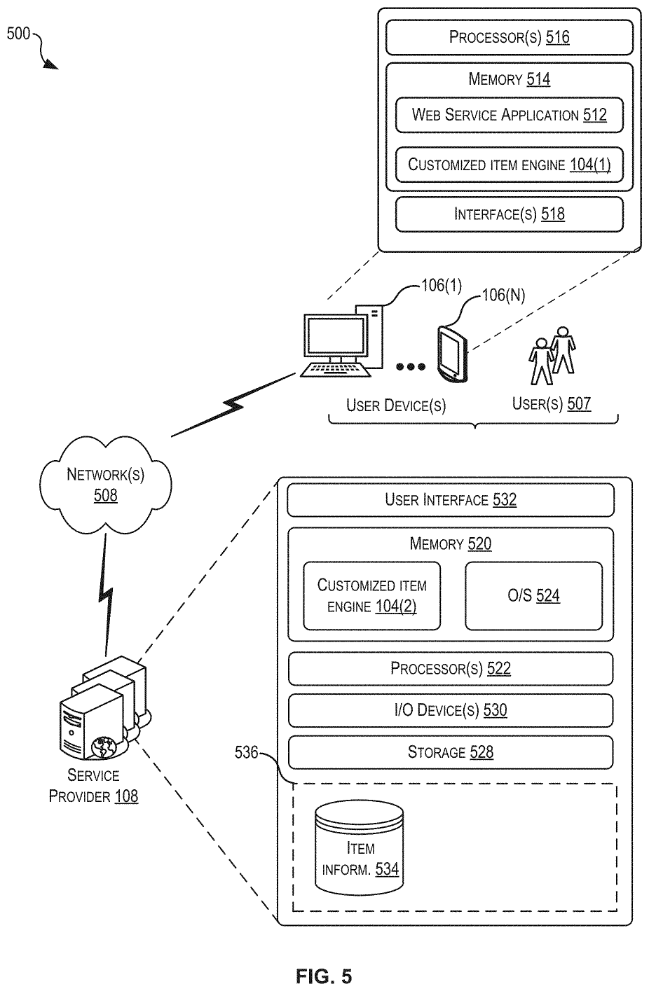

FIG. 5 is an example schematic architecture 500 for implementing techniques relating to generating and presenting visual indicators relating to dynamic item quantities, according to at least one example. The architecture 500 may include the service provider 108 in communication with one or more user devices 106(1)-106(N) via one or more networks 508 (hereinafter, “the network 508”).

The user device 106, which is an example of the user device 106, may be operable by one or more users 507 to interact with the service provider 108. The user device 106 may be any suitable type of computing device such as, but not limited to, a wearable device, a tablet, a mobile phone, a smart phone, a network-enabled streaming device (a high-definition multimedia interface (“HDMI”) microconsole pluggable device), a personal digital assistant (“PDA”), a laptop computer, a desktop computer, a thin-client device, a tablet computer, a high-definition television, a web-enabled high-definition television, a set-top box, etc. For example, the user device 106(1) is illustrated as a desktop computer, while the user device 106(N) is illustrated as an example of a handheld mobile device.

The user device 106 may include a memory 514 and processor(s) 516. In the memory 514 may be stored program instructions that are loadable and executable on the processor(s) 516, as well as data generated during the execution of these programs. Depending on the configuration and type of user device 106, the memory 514 may be volatile (such as random access memory (“RAM”)) and/or non-volatile (such as read-only memory (ROM), flash memory, etc.).

In some examples, the memory 514 may include a web service application 512 and a customized item engine 104(1). The web service application 512 and/or the customized item engine 104(1) may allow the user 507 to interact with the service provider 108 via the network 508. The user device 106 may also include one or more interfaces 518 to enable communication with other devices, systems, and the like.

Turning now to the details of the service provider 108, the service provider 108 may include one or more service provider computers, perhaps arranged in a cluster of servers or as a server farm, and may host web service applications. The function of the service provider 108 may be implemented a cloud-based environment such that individual components of the service provider 108 are virtual resources in a distributed environment. The service provider 108 also may be implemented as part of an electronic store (not shown). In some examples, onboarding processes may relate to the electronic store.

The service provider 108 may include at least one memory 520 and one or more processing units (or processor(s)) 522. The processor 522 may be implemented as appropriate in hardware, computer-executable instructions, software, firmware, or combinations thereof.

Computer-executable instruction, software, or firmware implementations of the processor 522 may include computer-executable or machine-executable instructions written in any suitable programming language to perform the various functions described. The memory 520 may include more than one memory and may be distributed throughout the service provider 108. The memory 520 may store program instructions that are loadable and executable on the processor(s) 522, as well as data generated during the execution of these programs. Depending on the configuration and type of memory including the service provider 108, the memory 520 may be volatile (such as RAM and/or non-volatile (such as read-only memory (“ROM”), flash memory, or other memory). The memory 520 may include an operating system 524 and one or more application programs, modules, or services for implementing the features disclosed herein including at least the customized item engine 104(2).

The service provider 108 may also include additional storage 528, which may be removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. The additional storage 528, both removable and non-removable, is an example of computer-readable storage media. For example, computer-readable storage media may include volatile or non-volatile, removable, or non-removable media implemented in any suitable method or technology for storage of information such as computer-readable instructions, data structures, program modules, or other data. As used herein, modules, engines, applications, and components may refer to programming modules executed by computing systems (e.g., processors) that are part of the service provider 108 and/or part of the user device 106.

The service provider 108 may also include input/output (I/O) device(s) and/or ports 530, such as for enabling connection with a keyboard, a mouse, a pen, a voice input device, a touch input device, a display, speakers, a printer, or other I/O device.

In some examples, the service provider 108 may also include one or more user interface(s) 532. The user interface 532 may be utilized by an operator, curator, or other authorized user to access portions of the service provider 108. In some examples, the user interface 532 may include a graphical user interface, voice interfaces, web-based applications, programmatic interfaces such as APIs, or other user interface configurations. The service provider 108 may also include the datastore 536. In some examples, the datastore 536 may include one or more databases, data structures, or the like for storing and/or retaining information associated with the service provider 108. Thus, the datastore 536 may include data structures, such as the item information database 534.

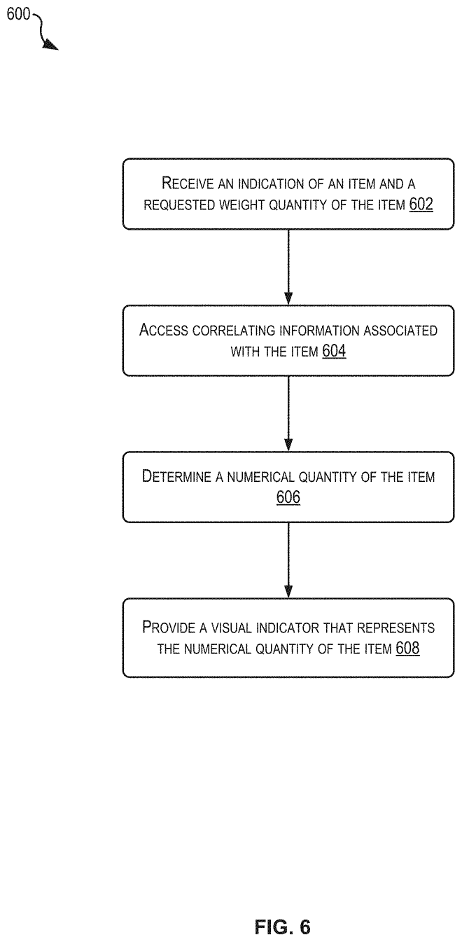

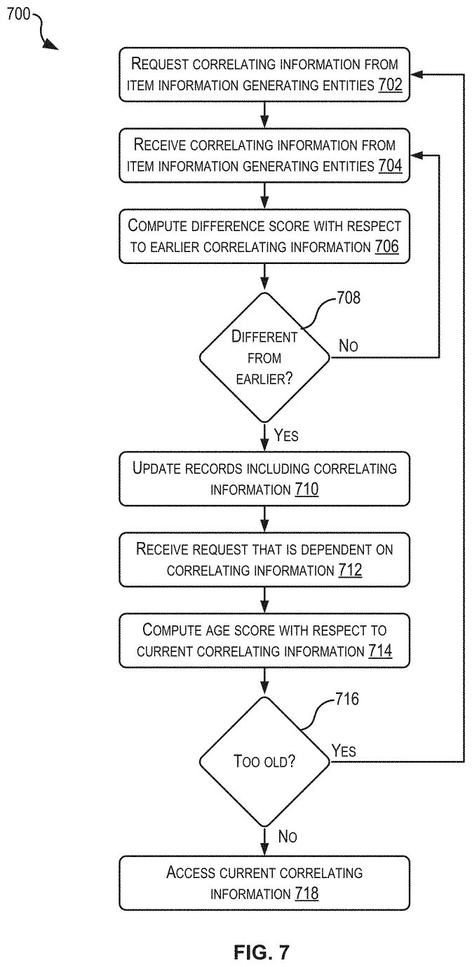

FIGS. 6 and 7 illustrate example flow diagrams showing respective processes 600 and 700, as described herein. These processes 600 and 700 are illustrated as logical flow diagrams, each operation of which represents a sequence of operations that can be implemented in hardware, computer instructions, or a combination thereof In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium is non-transitory.

FIG. 6 is a flow diagram of process 600 depicting example acts for implementing techniques relating to generating and presenting visual indicators relating to dynamic item quantities, according to at least one example. The customized item engine 104 (FIG. 1) embodied in the service provider 108 (FIG. 1) and/or within the user device 106 (FIG. 1) may perform the process 600. Thus, while the description below is from the perspective of the service provider 108, the user device 106 may also perform the method with only slight modifications.

The process 600 may begin at block 602 by the service provider 108 receiving an indication of an item and a requested weight quantity of the item. This may be included in a user request received via a user interface presented at the user interface (e.g., information received in a request from the user device 106). In some examples, the item may be a fungible item such as a food item. In some examples, the item may be an item that is typically purchased using a unit of measurement other than a regular or counting number. The item may be identified by a unique item identifier.

At block 604, the process 600 includes the service provider 108 accessing correlating information associated with the item. This may include the service provider 108 accessing the correlating information from a database of information, requesting the information from information generation entities, and/or obtaining in any other suitable manner. When the user device 106 performs the process 600, the user device may request the correlating information from the service provider 108 and/or may store the information locally on the device. As described herein, the correlating information correlates item weight with item quantity (e.g., an average weight of items of the same type as the item), as well as other information. The correlating information may include an average weight of a single fungible item of a type of the fungible item. The average weight may be updated in real-time, as described herein.

At block 606, the process 600 includes the service provider 108 determining a numerical quantity of the item. This may be based at least in part on the weight quantity and the correlating information. The numerical quantity may correspond to the requested weight quantity. The numerical quantity of the item may represent a counting or normal number of the items, given the weight quantity and the correlating information.

At block 610, the process 600 includes the service provider 108 providing a visual indicator that represents the numerical quantity of the item. The visual indicator may include a composite image that includes a plurality of visual representations of the item. In this example, the number of the plurality of visual representations may be equal to the numerical quantity. In some examples, the visual indicator may include a plurality of image tiles. The number of the plurality of image tiles may be equal to the numerical quantity. In this example, providing the visual indicator may include providing the plurality of image tiles within the area of the user interface. The plurality of image tiles may be equally sized. In some examples, the visual indicator may be a movie, model, or other visual identifier.

In some examples, the process 600 may further include, prior to providing the visual indicator of the item for presentation, generating, by the service provider 108, the visual indicator of the item based at least in part on characteristic information associated with the item.

In some examples, the characteristic information may include an average dimension of the item. For example, the average dimension may be represented by the correlating information or in other way(s) and may be updated periodically.

In some examples, the process 600 may further include selecting a reference image of a reference item based at least in part on characteristic information associated with the item, scaling the reference image of the reference item relative to the image of the item, and providing the reference image of the reference item for presentation adjacent to the area of the user interface.

In some examples, the weight quantity is a first weight quantity, the request is a first request, the numerical quantity is a first numerical quantity, and the visual indicator is a first visual indicator. In this example, the process 600 may further include the service provider 108 receiving a second weight quantity of the item within a second request, determining a second numerical quantity of the item based at least in part on the second weight quantity and the correlating information, and in the event the second numerical quantity is different than the first numerical quantity: generating a new visual indicator; and providing the new visual indicator of the item for presentation at the user interface.

In some examples, the request is a first request, the numerical quantity is a first numerical quantity, the weight quantity is a first weight quantity, and the visual indicator is a first visual indicator. In this example, the process 600 may further include the service provider 108, after providing the visual indicator of the item for presentation: receiving a second request identifying a second numerical quantity that is not equal to the first numerical quantity, determining a second weight quantity of the item based at least in part on the numerical quantity information and the correlating information, and providing the second weight quantity for presentation at the user interface.

In some examples, the area is divided into a plurality of image spaces and the visual indicator comprises a plurality of visual representations, each of which is presented in a respective image space.

In some examples, the item is a type of item that includes a plurality of sub-items (e.g., a hand of bananas may have multiple fingers), and the numerical quantity represents a quantity of sub-items (e.g., number of fingers), and the single image of the fungible item is a single image of a sub-item of the plurality of sub-items. In other words, the techniques described herein can be applied to items sold in different bunches/quantities than just singles. In this example, bananas may be sold by the pound, by the hand, or by the finger. If by the pound or by the hand, the techniques described herein may use the pound conversion rate or the hand-to-finger conversion rate to the number of corresponding fingers. This number will equal the number of image spaces generated, each of which may include a single image of a finger, or a hand with a set of fingers, depending on how offered via the electronic store.

In some examples, the request further includes a standard measure for a type of the requested fungible item. In this example, determining the numerical quantity may include determining the numerical quantity based at least in part on standard measure information that identifies a standard weight for the standard measure of fungible items of the type of the requested fungible item. For example, for apples, the standard measure may be a bushel. Other standard measures may be applicable to apples and to other items. In this example, determining the requested weight quantity may include determining the requested weight quantity based at least in part on standard measure information that identifies a standard weight for the standard measure of items of the type of the item. For example, the service provider 108 may maintain a conversion rate and/or a conversion table to determine a standard weight of a bushel of apples.

FIG. 7 is a flow diagram of process 700 depicting example acts for implementing techniques relating to generating and presenting visual indicators relating to dynamic item quantities, according to at least one example. The customized item engine 104 (FIG. 1) embodied in the service provider 108 (FIG. 1) and/or within the user device 106 (FIG. 1) may perform the process 700. Thus, while the description below is from the perspective of the service provider 108, the user device 106 may also perform the method with only slight modifications.

The process 700 begins at block 702 by the service provider 108 requesting correlating information from item information generating entities (e.g., 202). This may include the service provider accessing an externally facing service that maintains the information. For example, the service provider 108 may access one or more application programming interfaces (APIs) to obtain the correlating information from the item information generating entities 202.

At block 704, the process 700 includes the service provider 108 receiving correlating information from item information generating entities. This may be responsive to the request from the service provider 108. In some examples, the item information generating entities may send the correlating information to the service provider 108 at some fixed cadence (e.g., every hour, every day, every week, etc.), responsive to some event or trigger (e.g., responsive to a request, when the entity determines that new information has been collected, etc.), and/or in any other suitable manner. The service provider 108 may store the received information in association with the respective items.

At block 706, the process 700 includes the service provider 108 computing a difference score with respect to earlier correlating information. This may include comparing the correlating information, computing hashes of the two and comparing the hashes, performing a comparison using natural language processing, and/or using any other approach for comparing structured and/or unstructured information. A perfect match may have a score of 100, with less perfect matches having lower scores. Heuristics may be used to define guardrails and weights for computing the score.

At block 708, the process 700 includes the service provider 108 determining whether the received correlating information is sufficiently different from the earlier correlating information. This may include comparing the difference score with respect to a threshold. For example, if the score falls below 80, the answer at 708 may be yes. If above, 80, the answer may be no. Of course, 80 is an arbitrary selection; any other score value may be suitable, depending on the constraints of the system.

If the answer at block 708 is no, the process 700 returns to block 704 and checks to see if any additional correlating information has been received. If the answer at block 708 is yes, the process 700 proceeds to block 710. At block 710, the process 700 includes the service provider 108 updating records including correlating information. This may include updating item records in the item information database with the correlating information. In this manner, the item records may include essentially all information needed to respond to user requests and to populate the user interface 300.

At block 712, the process 700 includes the service provider 108 receiving a request that is dependent on the correlating information. For example, the request may be received from a user device and may be a request for a numerical quantity of items based on a weight quantity and the correlating information.

At block 714, the process 700 includes the service provider 108 computing an age score with respect to the current correlating information. The age score may represent the age of the current correlating information as compared to the earlier correlating information. This may enable the service provider 108 to conserve resources by only asking for updated correlating information when the current information is getting old. In some examples, the age score is a difference in age as represented in any suitable measure (e.g., milliseconds, seconds, minutes, hours, days, etc.).

At block 716, the process 700 includes the service provider 108 determining whether the current correlating information is too old. This may include comparing the age score with respect to an age threshold. If the age score is too high (indicating that the information is old and possibly stale), the process 700 includes the service provider 108 returning to block 702 and requesting correlating information. If the age score is below the threshold, the process 700 includes the service provider 108 accessing current correlating information, at block 718. The request of 712 may then be fulfilled using the current correlating information, rather than obtaining new information via the earlier blocks of the process 700.

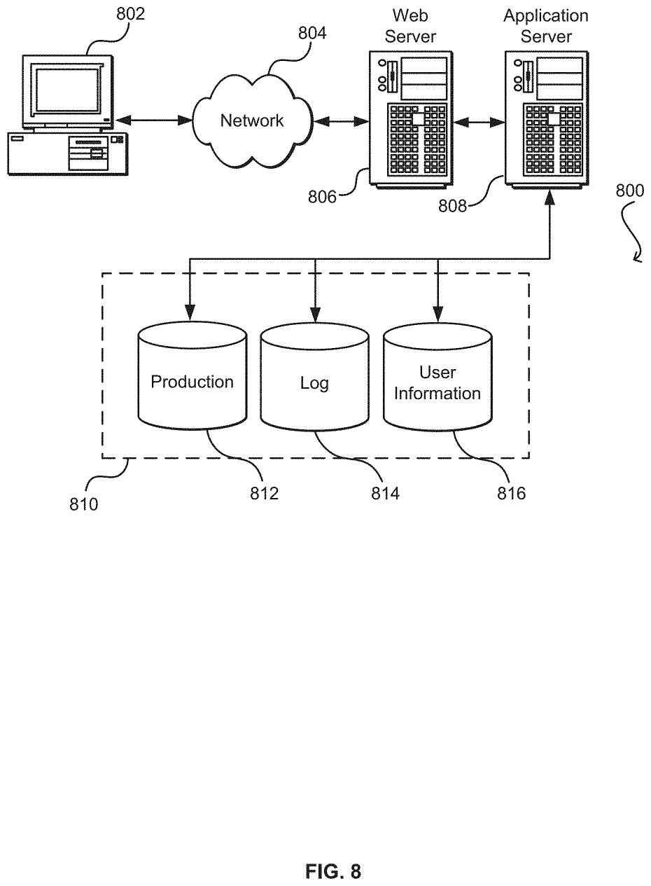

FIG. 8 illustrates aspects of an example environment 800 for implementing aspects in accordance with various examples. As will be appreciated, although a Web-based environment is used for purposes of explanation, different environments may be used, as appropriate, to implement various examples. The environment includes an electronic client device 802, which can include any appropriate device operable to send and receive requests, messages, or information over an appropriate network 804 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 806 for receiving requests and serving content in response thereto, although for other networks an alternative device serving a similar purpose could be used as would be apparent to one of ordinary skill in the art.

The illustrative environment includes at least one application server 808 and a data store 810. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language

(“HTML”), Extensible Markup Language (“XML”), or another appropriate structured language in this example. The handling of all requests and responses, as well as the delivery of content between the client device 802 and the application server 808, can be handled by the Web server. It should be understood that the Web and application servers are not required and are merely example components, as structured code discussed herein can be executed on any appropriate device or host machine as discussed elsewhere herein.

The data store 810 can include several separate data tables, databases or other data storage mechanisms and media for storing data relating to a particular aspect. For example, the data store illustrated includes mechanisms for storing production data 812 and user information 816, which can be used to serve content for the production side. The data store also is shown to include a mechanism for storing log data 814, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 810. The data store 810 is operable, through logic associated therewith, to receive instructions from the application server 808 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 802. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one example is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system 800 in FIG. 8 should be taken as being illustrative in nature and not limiting to the scope of the disclosure.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof

In examples utilizing a Web server, the Web server can run any of a variety of server or mid-tier applications, including Hypertext Transfer Protocol (“HTTP”) servers, FTP servers,

Common Gateway Interface (“CGP”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Storage media computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description.

The inventors expect skilled artisans to employ such variations as appropriate and the inventors intend for the disclosure to be practiced otherwise than as specifically described herein.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is

1. One or more non-transitory computer-readable media comprising computer-executable instructions that, when executed by one or more processors of a computing system, cause the computing system to perform operations, comprising:
receiving, via a user interface of a user device, a request comprising a requested fungible item and a requested weight quantity of the requested fungible item;
accessing, using information associated with the requested fungible item, correlating information that is specific to the requested fungible item and that correlates item weight of the requested fungible item with item quantity of the requested fungible item;
determining a numerical quantity of the requested fungible item corresponding to the requested weight quantity based at least in part on the requested weight quantity and the correlating information;
generating a composite image that represents the numerical quantity of the requested fungible item, the composite image comprising a plurality of visual representations of the requested fungible item that is equal to the numerical quantity; and
providing the composite image for presentation within an image space of the user interface.

2. The one or more non-transitory computer-readable media of claim 1, wherein the information associated with the requested fungible item comprises a unique item identifier.

3. The one or more non-transitory computer-readable media of claim 1, wherein the requested fungible item is a type of fungible item that comprises a plurality of sub-items, and the numerical quantity represents a quantity of sub-items, and the plurality of visual representations each represent a single a sub-item of the plurality of sub-items.

4. The one or more non-transitory computer-readable media of claim 1, wherein the request further comprises a standard measure for a type of the requested fungible item, and wherein determining the numerical quantity comprises determining the numerical quantity based at least in part on standard measure information that identifies a standard weight for the standard measure of fungible items of the type of the requested fungible item.

5. The one or more non-transitory computer-readable media of claim 1, wherein the correlating information comprises an average weight of a single fungible item of a type of the requested fungible item, and wherein the average weight is updated in real-time.

6. A computer-implemented method, comprising:
receiving, via a user interface of a user device, an indication of an item and a requested weight quantity of the item;
accessing correlating information that is specific to the item and correlates item weight with item quantity;
determining a numerical quantity of the item based at least in part on the requested weight quantity and the correlating information; and
providing, for presentation within an area of the user interface, a visual indicator that represents the numerical quantity of the item.

7. The computer-implemented method of claim 6, wherein the visual indicator comprises a composite image that includes a plurality of visual representations of the item, a number of the plurality of visual representations equal to the numerical quantity.

8. The computer-implemented method of claim 6, wherein the visual indicator comprises a plurality of image tiles, a number of the plurality of image tiles equal to the numerical quantity, and wherein providing the visual indicator comprises providing the plurality of image tiles within the area of the user interface.

9. The computer-implemented method of claim 8, wherein the plurality of image tiles are equally sized.

10. The computer-implemented method of claim 6, further comprising, prior to providing the visual indicator, generating the visual indicator based at least in part on characteristic information associated with the item.

11. The computer-implemented method of claim 10, wherein the characteristic information comprises an average dimension of the item.

12. The computer-implemented method of claim 6, further comprising:
selecting a reference image of a reference item based at least in part on characteristic information associated with the item;
scaling the reference image of the reference item relative to the visual indicator that represents the numerical quantity of the item; and
providing the reference image of the reference item for presentation adjacent to the area of the user interface.

13. The computer-implemented method of claim 6, wherein the correlating information comprises an average weight of the item.

14. The computer-implemented method of claim 6, wherein the area is divided into a plurality of image spaces that is equal to the numerical quantity, and wherein the visual indicator comprises a plurality of visual indicators for presentation within the plurality of image spaces.

15. The computer-implemented method of claim 6, wherein the correlating information is updated in real-time.

16. A computer system, comprising:
a display configured to present a user interface;
an input device configured to receive user inputs;
a memory configured to store computer-executable instructions; and
a processor configured to access the memory and execute the computer-executable instructions to at least:
receive, via the input device, a request for a weight quantity of an item;
access correlating information associated with the item and that correlates item weight with item quantity;
determine a numerical quantity of the item based at least in part on the weight quantity and the correlating information; and
provide, for presentation within an area of the user interface, a visual indicator that represents the numerical quantity of the item.

17. The computer system of claim 16, wherein the visual indicator comprises a plurality of image tiles, and wherein the processor is further configured to access the memory and execute additional computer-executable instructions to at least divide the area of the user interface into a plurality of spaces based at least in part on the numerical quantity, and wherein providing the visual indicator comprises providing an image tile for presentation in each of the plurality of spaces.

18. The computer system of claim 16, wherein accessing the correlating information comprises receiving the correlating information from a service provider.

19. The computer system of claim 16, wherein the numerical quantity comprises a count of the item that is equal to the weight quantity at an average item weight as represented by the correlating information.

20. The computer system of claim 16, wherein the visual indicator of the item comprises a stock image of a type of the item or an actual image of an example item of the type of the item.
